(19) United States
(12) Patent Application Publication
(10) Pub. No.: US 2015/0192998 A1
(43) Pub. Date: Jul. 9, 2015

(54) TACTILE SENSE CONTROL APPARATUS, TACTILE SENSE CONTROL METHOD, AND STORAGE MEDIUM

(71) Applicant: CANON KABUSHIKI KAISHA, Tokyo (JP)

(72) Inventors: Satoshi Ishimaru, Kawasaki-shi (JP); Toshimichi Ise, Yokohama-shi (JP)

(21) Appl. No.: 14/588,270

(22) Filed: Dec. 31, 2014

(30) Foreign Application Priority Data
Jan. 6, 2014 (JP) 2014-000521

(51) Int. Cl. G06F 3/01; G06F 3/041

(52) U.S. Cl. CPC G06F 3/016; G06F 3/041

(57) ABSTRACT

A tactile sense control apparatus includes a specifying unit that specifies a type of a tactile sense to be given to a user while a touch-input is being performed on an input surface, a tactile sense generation unit that generates a tactile sense to be given to the user via the input surface, and a control unit that controls the tactile sense generation unit to execute a first control for generating a first tactile sense when the specifying unit specifies a first type, execute a second control for generating a second tactile sense when the specifying unit specifies a second type, and stop the first control when the specifying unit changes the first type to the second type, execute a third control different from the first control and the second control, and then execute the second control.

### BACKGROUND

1. Field

Aspects of the present invention generally relate to a tactile sense control apparatus, a tactile sense control method, and a storage medium storing a program for giving a tactile sense to a user during a touching operation on a touch panel or the like.

2. Description of the Related Art

In recent years, in a mobile phone, an automatic teller machine (ATM) at a bank, a tablet personal computer (PC), or an electronic device such as a car navigation system, as an input device for receiving an operator's input operation, there has been widely used a touch sensor such as a touch panel. As for such a touch sensor, various methods such as a resistance film type and a capacitance type are employed.

The touch sensor itself is not physically displaced unlike a press button switch. This means that the operator actually touching the touch sensor with a finger or a stylus pen cannot acquire any feedback with respect to an input in any method. As a result, the operator cannot confirm whether any input has been received. Unable to confirm any input, the operator may perform a touching operation many times. Thus, in the touch sensor, no feedback may give stress to the operator.

To deal with the aforementioned problem, Japanese Patent Application Laid-Open No. 2011-048671 discussed a technique for enabling, when a touch sensor receives an input, an operator to recognize the reception of the input as a tactile sense by vibrating a touch surface of the touch sensor to give a tactile sense to a finger or the like.

However, in an apparatus capable of giving a plurality of kinds of tactile senses, when the tactile sense is changed, it is difficult for the operator to recognize the change of the tactile sense.

### SUMMARY

According to an aspect of the present invention, a tactile sense control apparatus includes a specifying unit configured to specify a type of a tactile sense to be given to a user while a touch-input is being performed on an input surface, a tactile sense generation unit configured to generate a tactile sense to be given to the user via the input surface, and a control unit configured to control the tactile sense generation unit to execute a first control for generating a first tactile sense when the specifying unit specifies a first type, execute a second control for generating a second tactile sense when the specifying unit specifies a second type, and stop the first control when the specifying unit changes the first type to the second type, execute a third control different from the first control and the second control, and then execute the second control.

Further features and aspects of the present disclosure will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and, together with the description, serve to explain the principles of the present disclosure.

FIG. 1 is a block diagram illustrating an electronic device.

FIG. 2 is a flowchart illustrating tactile sense control processing.

FIG. 3 is a diagram illustrating a relationship between a touch region and tactile sense control.

FIG. 4 is a flowchart illustrating tactile sense control processing.

FIG. 5 is a diagram illustrating a relationship between a touch region and tactile sense control.

### DESCRIPTION OF THE EMBODIMENTS

Various exemplary embodiments will be described in detail below with reference to the drawings.

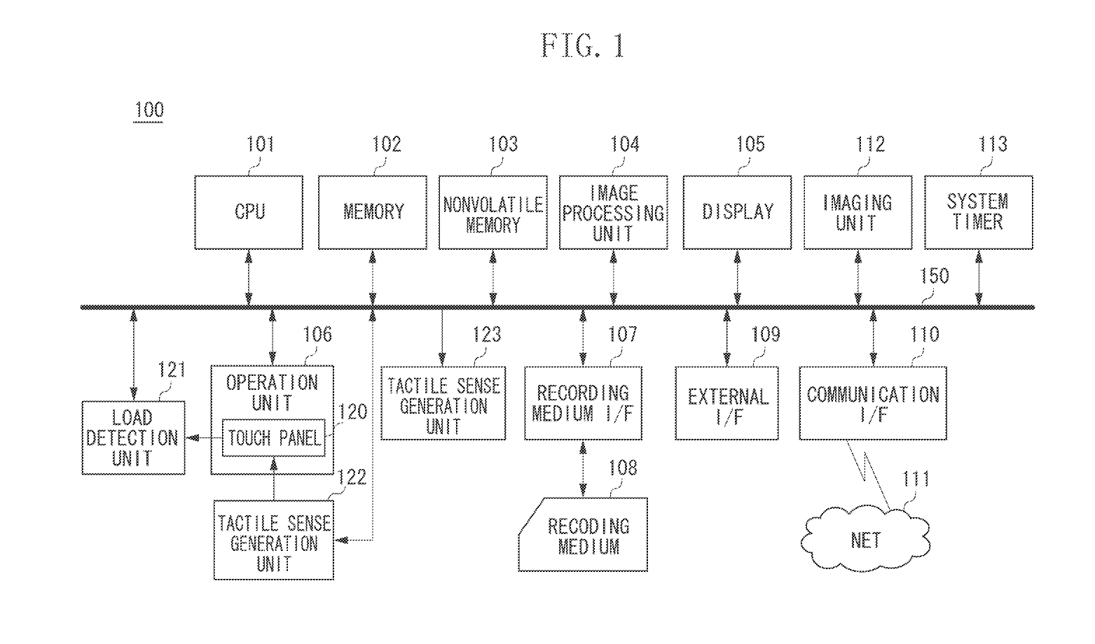

FIG. 1 is a block diagram illustrating an electronic device 100 serving as a tactile control apparatus. The electronic device 100 can be configured by using a mobile phone or the like. As illustrated in FIG. 1, a central processing unit (CPU) 101, a memory 102, a nonvolatile memory 103, an image processing unit 104, a display 105, an operation unit 106, a recording medium interface (I/F) 107, an external I/F 109, and a communication I/F 110 are connected to an internal bus 150. An imaging unit 112, a system timer 113, a load detection unit 121, and tactile sense generation units 122 and 123 are also connected to the internal bus 150. The units connected to the internal bus 105 can exchange data with one another via the internal bus 150.

The memory 102 includes, for example, a random access memory (RAM: volatile memory or the like utilizing semiconductor element). The CPU 101 controls, for example, according to a program stored in the nonvolatile memory 103, each unit of the electronic device 100 by using the memory 102 as a work memory. The nonvolatile memory 103 stores image data, audio data, and other data, and various types of programs for operating the CPU 101. The nonvolatile memory 103 includes, for example, a hard disk (HD) or a read-only memory (ROM).

The image processing unit 104 executes various types of image processing for image data under control of the CPU 101. The image data subjected to image processing is image data stored in the nonvolatile memory 103 or a recording medium 108, a video signal acquired via the external I/F 109, image data acquired via the communication I/F 110, or image data captured by the imaging unit 112.

The image processing carried out by the image processing unit 104 includes analog/digital (A/D) conversion processing, digital/analog (D/A) conversion processing, image data encoding processing, compression processing, decoding processing, enlargement/reduction processing (resizing), noise reduction processing, and color conversion processing. The image processing unit 104 is, for example, a circuit block dedicated to specific image processing. Depending on a type of image processing, in place of the image processing unit 104, the CPU 101 can execute the image processing according to the program.

The display 105 displays an image or a graphical user interface (GUI) screen under control of the CPU 101. The CPU 101 controls, according to the program, each unit of the electronic device 100 to generate a display control signal, generate a video signal to be displayed on the display 105, and output the video signal to the display 105. The display 105 displays a video based on the video signal.

As another example, the electronic device 100 may include, in place of the display 105 therein, an interface for externally outputting a video signal that can be displayed on the display 105. In this case, the electronic device 100 displays an image or the like on an external monitor (television or the like).

The operation unit 106 includes a character information input device such as a keyboard, a pointing device such as a mouse or a touch panel 120, and/or an input device such as a button, a dial, a joystick, a touch sensor, or a touch pad for receiving a user's operation. The touch panel 120 (input surface) is an input device configured on the display 105 to be planar, and configured to output coordinate information according to a touched position.

The recording medium 108 such as a memory card, a compact disk (CD), or a digital versatile disk (DVD) can be loaded into the storage medium I/F 107. The storage medium I/F 107 reads or writes data from/in the loaded recording medium 108 under control of the CPU 101.

The external I/F 109 is an interface for connecting to an external device by wire or wireless to input/output a video signal or an audio signal. The communication I/F 110 is an interface for communicating with the external device or the Internet 111 (including telephone communication) to transmit/receive various types of data such as a file or a command.

The imaging unit 112 is a camera unit that includes an image sensor such as a charge-coupled device (CCD) sensor or a complementary metal-oxide semiconductor (CMOS) sensor, a zoom lens, a focus lens, a shutter, a diaphragm, a distance-measuring unit, and an A/D converter. The imaging unit 112 can capture still and moving images. Image data of an image captured by the imaging unit 112 is transmitted to the image processing unit 104. At the image processing unit 104, the image data is subjected to various types of processing, and then recorded as a still or moving image file in the recording medium 108.

The system timer 113 is used for measuring time used for various types of control or time of a built-in clock.

The CPU 101 receives coordinate information of a touched position output from the touch panel 120 via the internal bus 150. The CPU 101 detects the following operations or states based on the coordinate information.
Touching operation on the touch panel 120 with a finger or a pen (hereinafter, referred to as a touch-down)
Touched state on the touch panel 120 with a finger or a pen (hereinafter, referred to as a touch-on)
Moving operation of a finger or a pen while touching the touch panel 120 with the finger or the pen (hereinafter, referred to as a move)
Removing operation of a finger or a pen from the touch panel 120 (hereinafter, referred to as a touch-up)
Untouched state on any part of the touch panel 120 (hereinafter, referred to as a touch-off)

When a move is detected, the CPU 101 determines a moving direction of a finger or a pen based on a coordinate change of a touched position. More specifically, the CPU 101 determines vertical and horizontal components of the moving direction on the touch panel 120.

The CPU 101 detects a stroke, flick, or drag operation. When a touch-up is performed after a certain movement from a touch-down state, the CPU 101 detects a stroke. When a movement of a predetermined distance or more and a predetermined speed or higher is detected, and a touch-up is subsequently detected, the CPU 101 detects a flick. When a movement of a predetermined distance or more and a speed lower than a predetermined speed is detected, the CPU 101 detects a drag.

The flick is an operation of quickly moving the finger by a certain distance while touching on the touch panel 120, and then removing the finger from the touch panel 120. In other words, the flick is a quick tracing operation of the finger on the touch panel 120 as if by flicking.

For the touch panel 120, any one of various types of touch panels including a resistance film type, a capacitance type, a surface acoustic wave type, an infrared-ray type, an electromagnetic induction type, an image recognition type, and an optical sensor type may be used.

The load detection unit 121 is provided integrally with the touch panel 120 by adhesion or other joining methods. The load detection unit 121 is made of a distortion gauge sensor configured to detect a load (pressing force) applied to the touch panel 120 by utilizing slight bending (distortion) of the touch panel 120 caused by the pressing force of a touching operation. As another example, the load detection unit 121 may be provided integrally with the display 105. In this case, the load detection unit 121 detects the load applied to the touch panel 120 via the display 105.

The tactile sense generation unit 122 generates a tactile sense to be given to an operation member such as a finger or a pen that operates the touch panel 120. In other words, the tactile sense generation unit 122 generates a stimulus perceivable by the user touching the panel though a touched portion. The tactile sense generation unit 122 is provided integrally with the touch panel 120. The tactile sense generation unit 122 includes a piezoelectric element, more specifically, a piezoelectric vibrator, configured to vibrate at an arbitrary amplitude and an arbitrary frequency under control of the CPU 101. Thus, the touch panel 120 bends and vibrates, and the vibration of the touch panel 120 is transmitted as a tactile sense to the operation member (operator). In other words, the tactile sense generation unit 122 is configured to give the tactile sense to the operator by its own vibration.

As another example, the tactile sense generation unit 122 may be provided integrally with the display 105. In this case, the tactile sense generation unit 122 bends and vibrates the touch panel 120 via the display 105.

The CPU 101 can generate tactile senses of various patterns by changing the amplitude and the frequency of the tactile sense generation unit 122 and vibrating the tactile sense generation unit 122 by various patterns.

The CPU 101 can control the tactile sense based on a touched position detected on the touch panel 120 and the pressing force detected by the load detection unit 121. For example, it is supposed that corresponding to a touching operation of the operator, the CPU 101 has detected a touched position corresponding to a button icon displayed on the display 105 and the load detection unit 121 has detected a pressing force of a predetermined value or higher. In this case, the CPU 101 generates vibration of about one cycle. This enables the user to perceive a tactile sense similar to a click feeling acquired when a mechanical button is pushed in.

It is further supposed that the CPU 101 executes a button icon function only when a pressing force of a predetermined value or higher is detected in a state where touching on a button icon position is detected. In other words, the CPU 101 does not execute any button icon function when a small pressing force is simply detected as in the case of touching the button icon. Thus, the user can perform an operation with feeling similar to that when the mechanical button is pushed in.

The load detection sensor 121 is not limited to the distortion gauge sensor. As another example, the load detection sensor 121 may include a piezoelectric element. In this case, the load detection sensor 121 detects the load based on a voltage output from the piezoelectric element based on the pressing force. The piezoelectric element used in the load detection unit 121 in this case may be common to the piezoelectric element used in the tactile sense generation unit 122.

The tactile sense generation unit 122 is not limited to the piezoelectric element configured to generate vibration. As another example, the tactile sense generation unit 122 may be configured to generate an electric tactile sense. For example, the tactile sense generation unit 122 includes a conductive layer panel and an insulator panel. As in the case of the touch panel 120, the conductive layer panel and the insulator panel are stacked on the display 105 to be planar. When the user touches the insulator panel, the conductive layer panel is positively charged. In other words, the tactile sense generation unit 122 can generate a tactile sense as an electric stimulus by applying positive charges to the conductive layer panel. The tactile sense generation unit 122 may give feeling (tactile sense) as if a skin is pulled by a coulomb force to the user.

As another example, the tactile sense generation unit 122 may include a conductive layer panel capable of selecting whether to positively charge each position on the panel. The CPU 101 controls a positive charging position. Thus, the tactile sense generation unit 122 can give various feelings such as “rugged”, “rough”, and “smooth” feelings to the user.

The tactile sense generation unit 123 generates a tactile sense by vibrating the entire electronic device 100. The tactile sense generation unit 123 includes, for example, an eccentric motor, and realizes a known vibration function. Accordingly, the electronic device 100 can give a tactile sense to a user's hand or the like holding the electronic device 100 by vibration generated by the tactile sense generation unit 123.

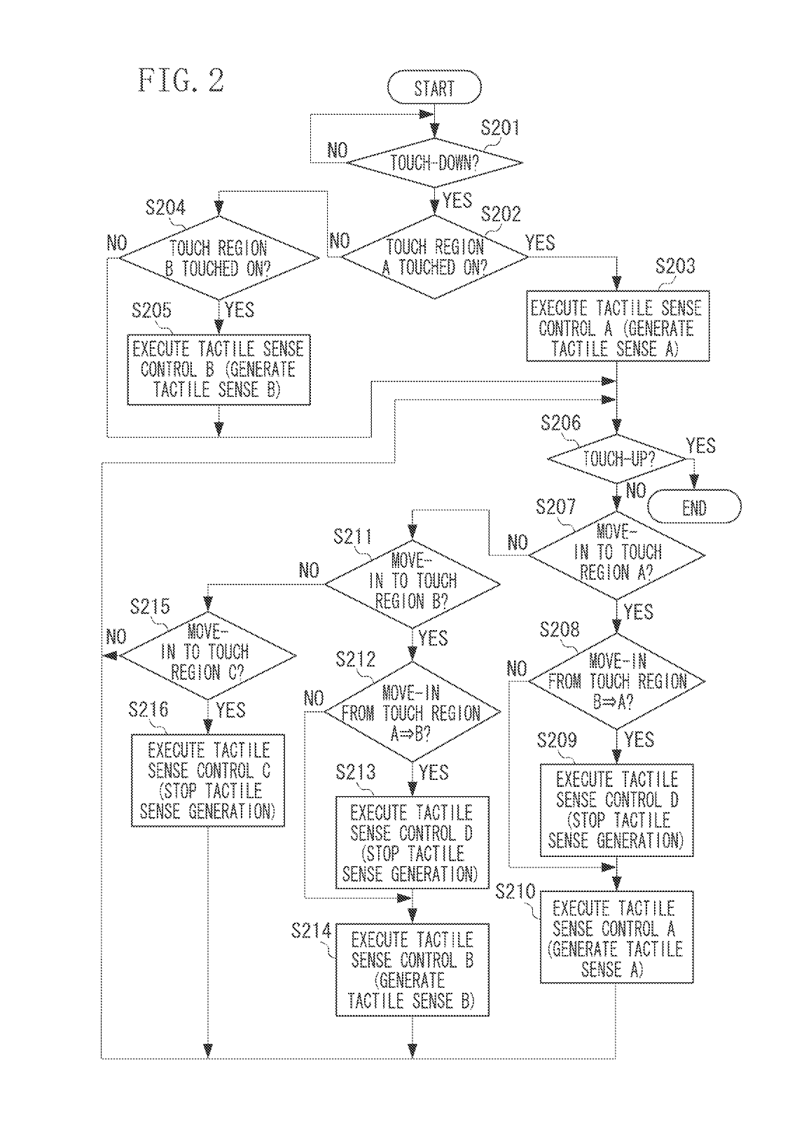

FIG. 2 is a flowchart illustrating tactile sense generation processing carried out by the electronic device 100. The electronic device 100 generates, in the tactile sense generation processing, a different tactile sense according to a touched region on the touch panel 120. The tactile sense generation processing is achieved in such a manner that the CPU 101 reads the program stored in the nonvolatile memory 103 and executes the program.

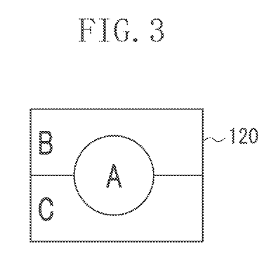

FIG. 3 is a diagram illustrating a relationship between a touched region and tactile sense control. According to the present exemplary embodiment, as illustrated in FIG. 3, the touch panel 120 is divided into three touch regions A to C.

Parts of the touch regions C and B are adjacent to each other at a straight line portion. Parts of the touch regions A and C and parts of the touch regions A and C are adjacent to each other at a boundary of a circular arc.

The region division method is only an example, and thus in no way limitative.

The electronic device 100 executes, when touch-on to the touch region A is detected, a tactile sense control A so as to notify the user of touching-on of the touch region A. The tactile sense control A is carried out to notify the user of a notification content indicating that the touch region A has been touched-on and touch-inputting is currently executed. More specifically, the tactile sense control A is for causing the tactile sense generation unit 122 to generate a tactile sense A.

Similarly, the electronic device 100 executes, when touch-on to the touch regions B and C is detected, the tactile sense controls A and B so as to notify the user of touching-on of the touch regions B and C. The tactile sense control B is carried out to notify the user of a notification content indicating that the touch region B has been touched-on and touch-inputting is currently executed. More specifically, the tactile sense control B is for causing the tactile sense generation unit 122 to generate a tactile sense B. The tactile senses A and B are different from each other. More specifically, the tactile senses A and B are different from each other in at least one of tactile sense type and tactile sense intensity. Further, the tactile sense control C is carried out to notify the user of a notification content indicating that the touch region C has been touched-on and touch-inputting is currently executed. More specifically, the tactile sense control C is for causing the tactile sense generation unit 122 to stop tactile sense generation.

The CPU 101 identifies, when touch-on to one of the touch regions A to C is detected, a notification content corresponding to the touch region, specifically, a type of a tactile sense given to the user, and executes tactile sense control (tactile sense control A, B, or C) corresponding to the specified notification content.

Hereinbelow, the tactile sense control processing will be described by taking an example of a case where the touch panel 120 is divided into three touch regions as in the case illustrated in FIG. 3. In step S201, the CPU 101 detects a presence of touch-down on the touch panel 120. The processing of step S201 is an example of detection processing for detecting touch-inputting. When the CPU 101 has detected touch-down (YES in step S201), the processing proceeds to step S202. When the CPU 101 has not detected any touch-down (NO in step S201), the processing stands by until a touch-down is detected.

In step S202, the CPU 101 determines whether the touch region A has been touched on. When the CPU 101 has determined that the region A has been touched on (YES in step S202), the processing proceeds to step S203. When the CPU 101 has determined that the region A has not been touched on (NO in step S202), the processing proceeds to step S204. In step S203, the CPU 101 specifies a notification content corresponding to the touch region A, specifically, a type of a tactile sense given to the user (specifying processing). The CPU 101 executes the tactile sense control A for the tactile sense generation unit 122 (control processing), and then the processing proceeds to step S206. The tactile sense generation unit 122 generates a tactile sense A under the tactile sense control A (tactile sense generation processing). The notification content indicating that the touch region A has been touched on is an example of a first notification content. The tactile sense control A is an example of first control processing.

In step S204, the CPU 101 determines whether the touch region B has been touched on. When the CPU 101 has determined that the region B has been touched on (YES in step S204), the processing proceeds to step S205. When the CPU 101 has determined that the region B has not been touched on (NO in step S204), the processing proceeds to step S206. In step S205, the CPU 101 specifies a notification content corresponding to the touch region B, specifically, a type of a tactile sense given to the user. The CPU 101 executes tactile sense control B for the tactile sense generation unit 122, and then the processing proceeds to step S206. The notification content indicating that the touch region B has been touched on is an example of a second notification content. The tactile sense control B is an example of second control processing.

In step S206, the CPU 101 detects a presence of touch-up on the touch panel 120. When the CPU 101 has detected a touch-up (YES in step S206), the tactile sense control processing is ended. When the CPU 101 has not detected any touch-up (NO in step S206), the processing proceeds to step S207.

In step S207, the CPU 101 determines whether a move-in has been made to the touch region A. When the CPU 101 has determined that a move-in has been made to the touch region A (YES in step S207), the processing proceeds to step S208. When the CPU 101 has determined that any move-in has not been made to the touch region A (NO in step S207), the processing proceeds to step S211.

In step S208, the CPU 101 determines whether the move-in has been made from the touch region B to the touch region A. When the CPU 101 has determined that the move-in has been made from the touch region B to the touch region A (YES in step S208), the processing proceeds to step S209. When the CPU 101 has determined that any move-in has not been made from the touch region B to the touch region A (NO in step S208), the processing proceeds to step S210. The processing of step S208 is an example of identifying processing for identifying a change of a notification content.

In step S209, the CPU 101 executes a tactile sense control D for a period of execution time, and then the processing proceeds to step S210. The tactile sense control D is for causing the tactile sense generation unit 122 to stop the tactile sense generation. The execution time is stored in advance in, for example, the nonvolatile memory 103. The tactile sense control D is an example of third control processing. In step S210, the CPU 101 executes the tactile sense control A, and then the processing proceeds to step S206.

In this way, the CPU 101 sets, when a touching position of the operation member changes from the touch region B to the touch position A adjacent to the region B, a period for not giving any tactile sense after a stop of the tactile sense B and before a generation start of the tactile sense A rather than simply switching a tactile sense to be generated from the tactile sense B to the tactile sense A. Thus, when the tactile sense changes, by canceling giving of the tactile sense, the user can recognize the change of the tactile sense more surely.

In step S211, the CPU 101 determines whether move-in has been made to the touch region B. When the CPU 101 has determined that a move-in has been made to the touch region B (YES in step S211), the processing proceeds to step S212. When the CPU 101 has determined that any move-in has not been made to the touch region B (NO in step S211), the processing proceeds to step S215.

In step S212, the CPU 101 determines whether the move-in has been made from the touch region A to the touch region B. When the CPU 101 has determined that the move-in has been made from the touch region A to the touch region B (YES in step S212), the processing proceeds to step S213. When the CPU 101 has determined that the move-in has not been made from the touch region A to the touch region B (NO in step S212), the processing proceeds to step S214. The processing of step S212 is an example of identifying processing for identifying a change of a notification content.

In step S213, the CPU 101 executes the tactile sense control D for a period of execution time, and then the processing proceeds to step S214. In step S214, the CPU 101 executes the tactile sense control B, and then the processing proceeds to step S206.

In this way, the CPU 101 sets, when a touching position of the operation member changes from the touch region A to the touch position B, a period for not giving any tactile sense after a stop of the tactile sense A and before a generation start of the tactile sense B. Thus, the user can recognize the change of the tactile sense more surely.

A region to which the tactile sense D is provided is originally the touch region A to which the tactile sense A is to be given or the touch region B to which the tactile sense B is to be given. Thus, when not movement from one of the touch regions A and B to the other but direct touching on the touch region A or B is started, a tactile sense corresponding to the region is originally provided.

In step S215, the CPU 101 determines whether a move-in has been made to the touch region B. When the CPU 101 has determined that a move-in has been made to the touch region B (YES in step S215), the processing proceeds to step S216. When the CPU 101 has determined that any move-in has not been made to the touch region B (NO in step S215), the processing proceeds to step S206. In step S216, the CPU 101 identifies a notification content indicating that the touch region C has been touched on, specifically, a type of a tactile sense. The CPU 101 executes the tactile sense control C for the tactile sense generation unit 122, and then the processing proceeds to step S206. The tactile sense control C is for causing the tactile sense generation unit 122 to stop the tactile sense generation.

As discussed above, the electronic device 100 stops, when changing the tactile sense, generation of a tactile sense for the period of execution time after stopping a currently generated tactile sense, and then generates a new tactile sense different from the stopped tactile sense. As a result, the user can recognize the change of the tactile sense more surely.

A first modified example of the electronic device 100 according to the first exemplary embodiment will be described. The tactile sense control D executed by the electronic device 100 is only required to enable the user to recognize a change of a notification content (in the present exemplary embodiment, touch region to which a touch-input has been performed), and a specific control method is not limited to that of the exemplary embodiment. As another example, the CPU 101 may execute, as the tactile sense control D, control for giving the tactile sense D higher in tactile sense intensity than the tactile senses A and B.

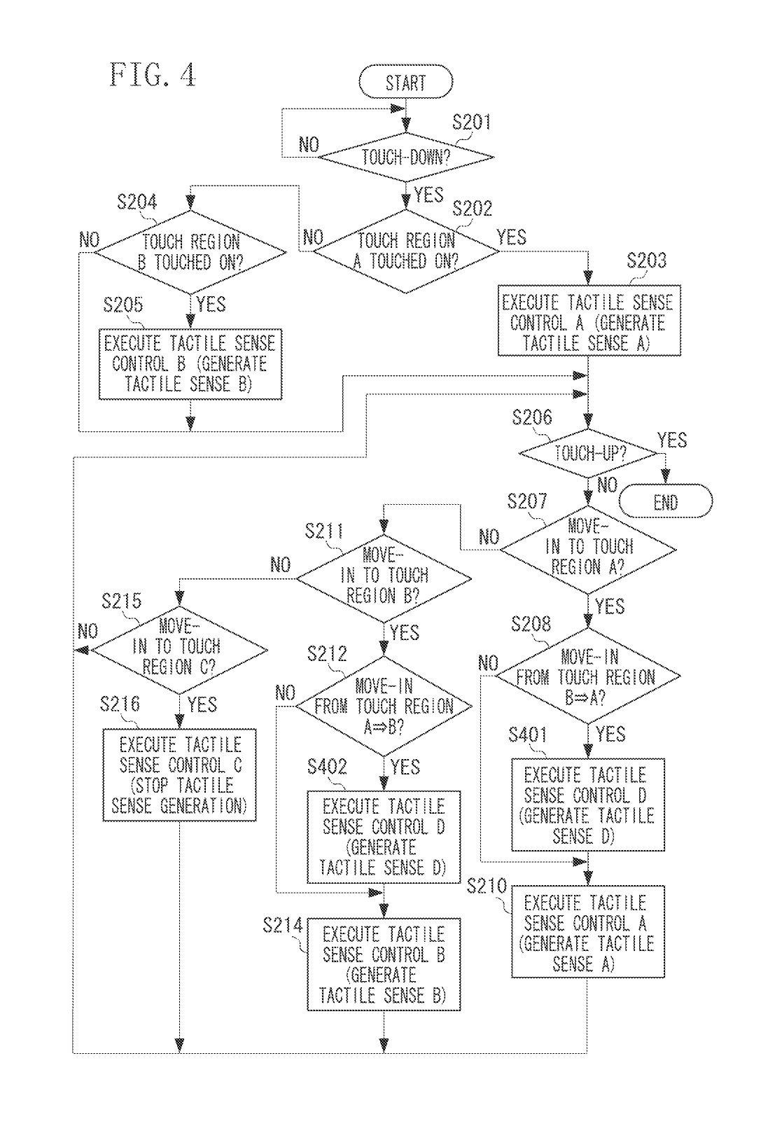

FIG. 4 is a flowchart illustrating tactile sense control processing according to the first modified example. In FIG. 4, steps similar to those of the tactile sense control processing illustrated in FIG. 2 are denoted by the same numbers. Portions different from the tactile sense control processing illustrated in FIG. 2 will be described. According to the first modified example, when the CPU 101 has determined a move-in has been made from the touch region B to the touch region A (YES in step S208), the processing proceeds to step S401. In step S401, the CPU 101 generates, as a tactile sense control D, a tactile sense D for a period of execution time, and then the processing proceeds to step S210.

When the CPU 101 has determined that a move-in has been made from the touch region A to the touch region B (YES in step S212), the processing proceeds to step S402. In step S402, the CPU 101 generates, as a tactile sense control D, a tactile sense D for a period of execution time, and then the processing proceeds to step S210. Similarly, in this case, the user can recognize a change of the tactile sense more surely.

According to a second modified example, execution time of a third control may not be a fixed value. For example, the CPU 101 may determine the execution time according to a moving speed from the touch region to the touch region A (determination processing). More specifically, the CPU 101 determines shorter execution time as a moving speed is faster.

According to a third modified example, the touch panel 120 may be disposed at a position away from the display 105. In this case, a position on the touch panel 120 and a position on the display 105 are related to each other, and the CPU 101 can receive an instruction input corresponding to a position on the display 105 according to a touch-input to each position on the touch panel 120.

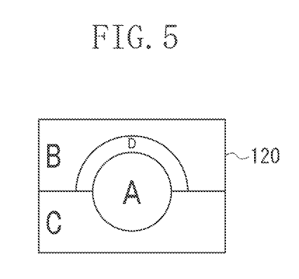

FIG. 5 illustrates an electronic device 100 according to a second exemplary embodiment. In the electronic device 100 according to the second exemplary embodiment, on a touch panel 120, a touch region for giving no tactile sense is set (disposed) between a plurality of touch regions in which tactile senses to be generated corresponding to a touch-on are different. The plurality of touch regions in which tactile senses to be generated corresponding to a touch-on are different is an example of a plurality of touch regions in which notification contents to a user are different.

In the example illustrated in FIG. 5, a touch region D is set between the touch regions A and B. The touch region D is set for the purpose of notifying the user of a change of a touch region. According to the present exemplary embodiment, the touch region D is a region for not giving any tactile sense to the user. In other words, when it is determined that the touch region D has been touched on, a CPU 101 executes a tactile sense control D for a tactile sense generation unit 122 to stop tactile sense generation. The tactile sense control D may be a control for generating a tactile sense D different from the tactile senses A to C.

As described above, on the touch panel 120 of the electronic device 100 according to the second exemplary embodiment, the touch region for notifying the user of the change of the touch region is set between the touch regions corresponding to the different tactile senses. Therefore, in the electronic device 100 according to the present exemplary embodiment, the processing of steps S207 to S214 illustrated in FIG. 2 is not required. The electronic device 100 according to the present exemplary embodiment is only required to determine which of the touch regions A to D has been touched on and to execute a control corresponding to the touched-on region.

As a result, the electronic device 100 according to the present exemplary embodiment can achieve a similar tactile sense control even without performing the processing of steps S207 to S214 illustrated in FIG. 2.

Other components and processes of the electronic device 100 according to the second exemplary embodiment are similar to those of the electronic device 100 according to the first exemplary embodiment.

### OTHER EMBODIMENTS

Additional embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-000521 filed Jan. 6, 2014, which is hereby incorporated by reference herein in its entirety.

What is claimed is:

1. A tactile sense control apparatus comprising:
a specifying unit configured to specify a type of a tactile sense to be given to a user while a touch-input is being performed on an input surface;
a tactile sense generation unit configured to generate a tactile sense to be given to the user via the input surface; and
a control unit configured to control the tactile sense generation unit to:
execute a first control for generating a first tactile sense when the specifying unit specifies a first type;
execute a second control for generating a second tactile sense when the specifying unit specifies a second type; and
stop the first control when the type of a tactile sense specified by the specifying unit is changed from the first type to the second type, execute a third control different from the first control and the second control, and then execute the second control.

2. The tactile sense control apparatus according to claim 1, wherein the control unit executes as the third control, control for stopping the tactile sense generation by the tactile sense generation unit.

3. The tactile sense control apparatus according to claim 1, wherein the control unit causes, as the third control, the tactile sense generation unit to generate a tactile sense larger in intensity than the first and second tactile senses.

4. The tactile sense control apparatus according to claim 1, further comprising a determination unit configured to determine, in the first control, while the touch-input is being performed to a first region of the input surface, and in the second control, a touch-input is being performed to a second region of the input surface, when movement is made from the first region to the second region while executing the touch-input, execution time of the third control based on a moving speed,
wherein the control unit causes the tactile sense generation unit to execute the third control for a period of the execution time determined by the determination unit.

5. A tactile sense control apparatus comprising:
a detection unit configured to detect a touch-input made by a user on an input surface;
a tactile sense generation unit configured to generate a tactile sense to be given to the user via the input surface; and
a control unit configured to control the tactile sense generation unit to:
execute a first control for generating a first tactile sense when the detection unit detects a touch-input to a first region of the input surface, execute a second control for generating a second tactile sense when the detection unit detects a touch-input to a second region of the input surface, and execute a third control different from the first control and the second control when the touch input moves to the second region adjacent to the first region while touching the first region.

6. The tactile sense control apparatus according to claim 5, wherein the control unit stops, as the third control, the tactile sense generation of the tactile sense generation unit.

7. The tactile sense control apparatus according to claim 5, wherein the control unit causes, as the third control, the tactile sense generation unit to generate a tactile sense larger in intensity than the first and second tactile senses.

8. A method for controlling a tactile sense generation unit configured to generate a tactile sense to be given to a user via an input surface, the method comprising:
specifying a type of a tactile sense to be given to the user while a touch-input is being performed on the input surface;
executing a first control to generate a first tactile sense when a first type is specified;
executing a second control to generate a second tactile sense when a second type is specified; and
controlling the tactile generation unit to stop the first control when a change from the first type to the second type is specified, to execute a third control different from the first control and the second control, and then execute the second control.

9. The method according to claim 8, wherein in the third control, the tactile sense generation unit is caused to stop the tactile sense generation.

10. The method according to claim 8, wherein, in the third control, the tactile sense generation unit is caused to generate a tactile sense larger in intensity than the first and second tactile senses.

11. The method according to claim 8, further comprising determining, in the first control, while the touch-input is being performed to a first region of the input surface, and as the second control, a touch-input is being performed to a second region of the input surface, when movement is made from the first region to the second region while executing the touch-input, execution time of the third control based on a moving speed,
wherein the tactile sense generation unit is caused to execute the third control for a period of the determined execution time.

12. A method for controlling a tactile sense generation unit configured to generate a tactile sense to be given to a user via an input surface, the method comprising:
detecting a touch-input made by a user on the input surface;
generating a tactile sense to be given to the user via the input surface; and
executing a first control to generate a first tactile sense when the touch-input to a first region of the input surface is detected, executing second control to generate a second tactile sense when the touch-input to a second region of the input surface is detected, and executing a third control different from the first control and the second control when the touch-input moves to the second region adjacent to the first region while touching the first region.

13. The method according to claim 12, wherein, in the third control, the tactile sense generation unit is caused to stop the tactile sense generation.

14. The method according to claim 12, wherein, in the third control, the tactile sense generation unit is caused to generate a tactile sense larger in intensity than the first and second tactile senses.

15. A computer-readable storage medium that stores computer executable instructions for causing a computer to control a tactile sense generation unit configured to generate a tactile sense to be given to a user via an input surface to execute a method, the method comprising:
specifying a type of a tactile sense to be given to the user while a touch-input is being performed on the input surface;
executing a first control to generate a first tactile sense when a first type is specified;
executing a second control to generate a second tactile sense when a second type is specified; and
controlling the tactile generation unit to stop the first control when a change from the first type to the second type is specified, to execute a third control different from the first control and the second control, and then execute the second control.

16. A computer-readable storage medium that stores computer executable instructions for causing a computer to control a tactile sense generation unit configured to generate a tactile sense to be given to a user via an input surface to execute a method, the method comprising:
detecting a touch-input made by a user on the input surface;
generating a tactile sense to be given to the user via the input surface; and
executing a first control to generate a first tactile sense when the touch-input to a first region of the input surface is detected, executing second control to generate a second tactile sense when the touch-input to a second region of the input surface is detected, and executing a third control different from the first control and the second control when the touch-input moves to the second region adjacent to the first region while touching the first region.
